(19) United States
(12) Patent Application Publication
(10) Pub. No.: US 2025/0181898 A1
(43) Pub. Date: Jun. 5, 2025

(54) OPTIMIZING PREDICTIVE ACCURACY ON GRAPHICAL NEURAL NETWORKS (GNN) UTILIZING EDGE AND NODE AGGREGATION

(71) Applicant: International Business Machines Corporation, Armonk, NY (US)

(72) Inventors: Ryo Kawahara, Toshima-ward (JP); Mikio Takeuchi, Yokohama (JP)

(21) Appl. No.: 18/529,086

(22) Filed: Dec. 5, 2023

(51) Int. Cl. G06N 3/0464

(52) U.S. Cl. CPC G06N 3/0464

(57) ABSTRACT

One or more systems, devices, computer program products and/or computer-implemented methods of use provided herein relate to predicting a optimized result for a GNN. A system can comprise a memory configured to store computer executable components; and a processor configured to execute the computer executable components stored in the memory, wherein the computer executable components can comprise a convolution aggregation component that aggregates features through incoming edges, and aggregates features through outgoing edges to learn the different roles of those edges. Also a node level aggregation component that aggregates edge attributes and node features from neighborhood nodes and edges to optimize computing workload and memory, and a generating component that generates a prediction for an input graph, or for a part of a graph such as a node (vertex), an edge, or a subgraph, based on the node attributes (features) and edge attributes that are attached to the input graph.

### BACKGROUND

The subject disclosure relates to Graph Neural Networks (GNN) implementing dual flow and edge feature-enabled aggregation to capture the role of directed and attributed edges that drive CPU, memory and predictive optimization.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable prediction of future possibility of bias in an AI model are discussed.

According to an embodiment, a computer-implemented system is provided. The computer-implemented system can comprise a memory configured to store computer executable components; and a processor configured to execute the computer executable components stored in the memory, wherein the computer executable components can comprise a convolution aggregation component that aggregates features through incoming edges, and aggregates features through outgoing edges to learn the different roles of those edges, a node level aggregation component that aggregates edge attributes and node features from neighborhood nodes and edges to optimize computing workload and memory; and a generating component that generates a prediction for an input graph, or for a part of a graph such as a node (vertex), an edge, or a subgraph, based on the node attributes (features) and edge attributes that are attached to the input graph.

According to another embodiment, a computer-implemented method is provided. The method can execute convolution, by a system operatively coupled to a processor, that aggregates features through incoming edges, and aggregates features through outgoing edges to learn the different roles of those edges, aggregation by the system that aggregates edge attributes and node features from neighborhood nodes and edges to optimize computing workload and memory; and generating by the system a prediction for an input graph, or for a part of a graph such as a node (vertex), an edge, or a subgraph, based on the node attributes (features) and edge attributes that are attached to the input graph.

According to yet another embodiment, a computer program product for predicting a target variable using Graph Neural Network. The computer program product can comprise a computer readable storage medium having program instructions embodied therewith, the program instructions executable by a processor to cause the processor to aggregate, by the processor, features through incoming edges, and aggregates features through outgoing edges to learn different roles of those edges, and predict, by the processor, for an input graph, or for a part of a graph such as a node (vertex), an edge, or a subgraph, based on the node attributes (features) and edge attributes that are attached to the input graph.

### DESCRIPTION OF THE DRAWINGS

FIG. 1 illustrates a block diagram of a non-limiting system that can predict outcomes for items e.g., such as financial fraud, money laundering, credit risk and so on, utilizing graphical data in accordance with one or more embodiments described herein.

FIG. 2 illustrates a schematic diagram of node level aggregation with edge attributes of a non-limiting system with one or more embodiments described herein.

FIG. 3 illustrates a schematic diagram of dual flow convolution encompassing incoming and outgoing edges with edge attributes of a non-limiting system in accordance with one or more embodiments described herein.

FIG. 4 illustrates a component diagram of dual flow convolution for a non-limiting system in accordance with one or more embodiments described herein.

FIG. 5 illustrates a flow chart of GNN functionality for a non-limiting system in accordance with one or more embodiments described herein.

FIG. 6 illustrates a flow chart for the DEFGAT (Dual Flow Edge Feature Convoluted Graph Attention Network) layer within the innovation overall flow chart of a non-limiting system in accordance with one or more embodiments described herein.

FIG. 7 illustrates a dual flow convolution flow chart of a non-limiting system in accordance with one or more embodiments described herein.

FIG. 8 illustrates a block diagram of an example, non-limiting, operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Graph Neural Networks (GNNs) are a class of neural network models designed to operate on graph-structured data. Graphs consist of nodes (vertices) connected by edges (links), and they are a versatile way to represent data with complex relationships and structures, such as social networks, recommendation systems, biology, knowledge graphs, and more. GNNs were developed to perform machine learning tasks on such graph-structured data. Some of the different components used in a GNN are as follows. There are node features in a graph, in which each node on a graph has associated features or attributes specific to the node, like user profiles in a social network or chemical properties in a molecular graph. There is message passing which is often a significant operation of a GNN. GNNs iteratively update representation of nodes by aggregating information from neighbouring nodes. This allows nodes to take into account features and relationships of connected nodes. GNNs also employ aggregation in which aggregated information is typically combined through a neural network layer (e.g., a weighted sum or a more complex operation), which may include both a node's own features and information from its neighbours. After aggregating information from neighbours, a new representation of the node is generated. This updated representation can be used for various downstream tasks, e.g., such as classification, regression, or clustering.

In GNNs, a same neural network architecture is used for respective nodes in a graph, and the parameters (weights) are shared across nodes. This is similar to how convolutional layers share weights in Convolutional Neural Networks (CNNs). GNNs can have multiple layers, allowing for propagation of information across a graph through multiple iterations of message passing. This enables GNNs to capture complex dependencies and relationships within the graph.

Common architectures and variations of GNNs include but are not limited to Graph Convolutional Networks (GCNs), GraphSAGE, Graph Isomorphism Networks (GIN), and GATs (Graph Attention Networks). GATs are designed to work with graph-structured data and are particularly well-suited for tasks that involve learning from relationships between nodes in a graph. GATs can have greater ability to effectively capture complex dependencies and variations in graph data. These models have been successfully applied to various tasks, such as node classification, link prediction, graph classification, and more. GNNs have become a significant tool for analysing and making predictions on graph-structured data in a wide range of applications e.g., such as detecting money laundering, financial fraud, credit risk analysis and more.

Graph Neural Networks (GNNs) can be employed to detect financial fraud by modeling and analyzing the complex relationships and interactions among financial entities, such as account holders, transactions, and other entities in a financial network. GNNs can function by using some techniques as described below.

Below are some common features of GNNs.

Data Representation: Represent a financial network as a graph, where nodes represent entities (e.g., account holders, merchants, or financial transactions), and edges represent various relationships or interactions between these entities (e.g., transactions between accounts).

Node Features: Assign features to each node in the graph. Node features may include information about the account's transaction history, behavior, demographics, account balance, or any relevant attributes.

Anomaly Detection: Use GNNs for anomaly detection by training a model to distinguish between normal and potentially fraudulent behavior. This can be done in a semi-supervised manner, where there are labeled examples of both normal and fraudulent behavior and use a GNN to generalize to detect new instances of fraud.

Graph Structure: Leveraging a graph structure to capture dependencies and interactions between nodes. GNNs are well-suited for this because they can propagate information through a graph, learning patterns and relationships among entities.

Message Passing is a key idea behind GNN functionality, where information from neighboring nodes is aggregated and used to update representation of a node. GNNs learn to capture structural patterns and relationships within a graph, making them powerful tools for analyzing and making predictions on graph-structured data. In a GNN, a goal is to learn representations for respective nodes that capture information from neighbouring nodes, allowing a model to understand and utilize a graph's structure and relationships.

Feature Engineering: for financial discovery, features or attributes to nodes or edges can capture patterns associated with fraudulent behavior. This could include features related to transaction frequency, transaction amounts, or any other relevant financial metrics.

Semi-Supervised Learning: GNNs are particularly useful when there is limited labeled data. They can propagate information and labels through a graph to make predictions for unlabeled nodes. Train the GNN using labeled examples of fraudulent and non-fraudulent transactions. The GNN learns to propagate information and capture patterns that are indicative of fraud.

Prediction and Detection: After training, use a GNN to make predictions on new or unlabeled instances. If a GNN identifies instances with characteristics similar to known fraud patterns, it may raise an alert or flag them for further investigation. This new innovation provides various modifications to standard GNN functionality to optimize predictive results.

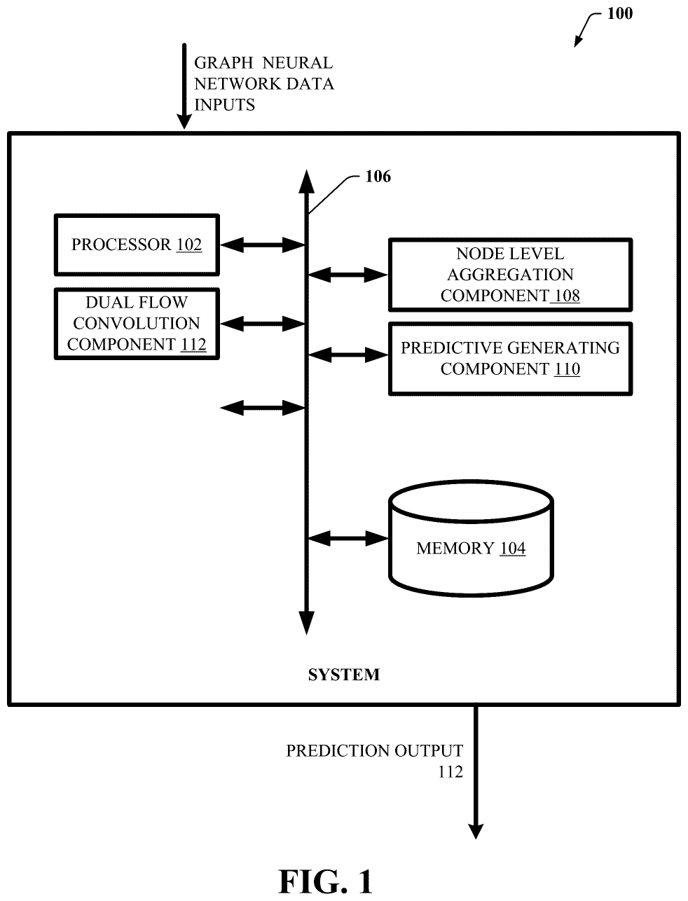

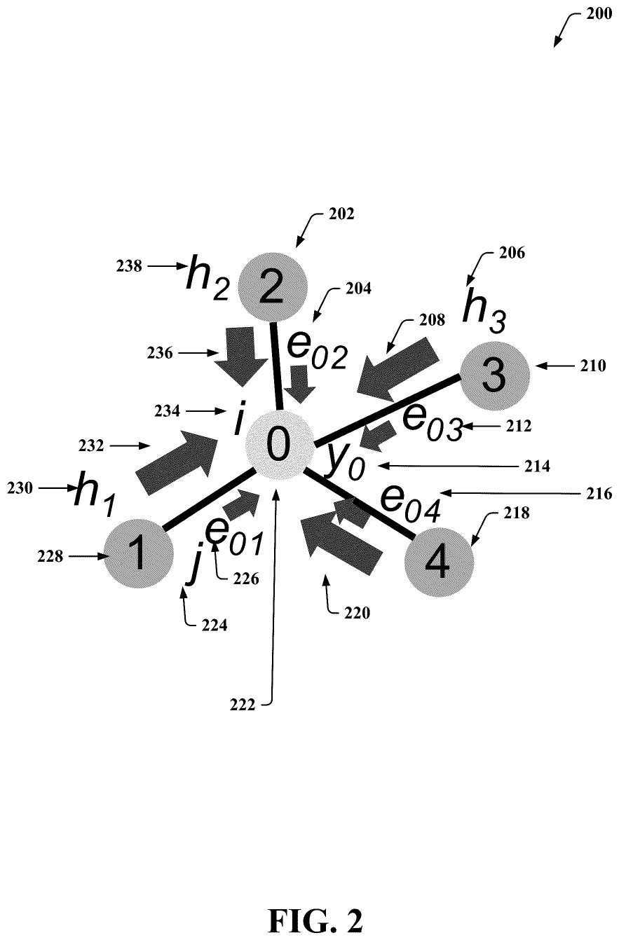

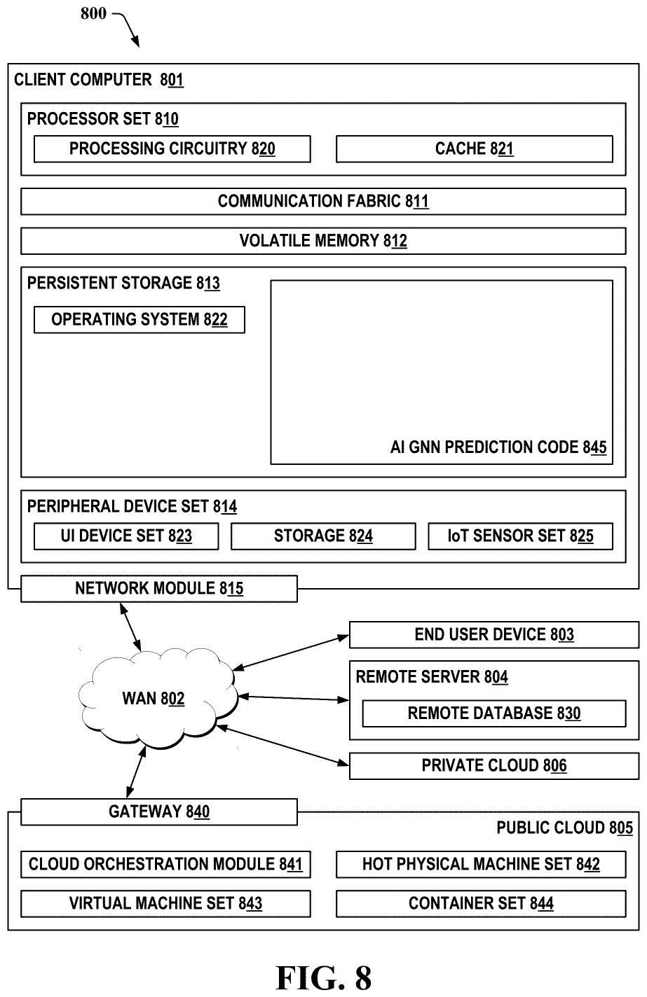

FIG. 1 illustrates a block diagram of an example, non-limiting system 100 that can predict potential cases of financial fraud, money laundering, credit risk analysis and perform other types of financial checks in an GNN model in accordance with one or more embodiments described herein. System 100 can comprise processor 102, memory 104, system bus 106, node aggregation component 108, predictive generation component 110, and dual convolution component 112. One or more aspects of the non-limiting system 100 can be described in conjunction with one or more embodiments in FIG. 2 thru FIG. 8.

Discussion first turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., node aggregation component 108, predictive generating component 110, and/or the dual convolution component 118 to perform one or more actions. In one or more embodiments, memory 104 can store computer-executable components (e.g., node aggregation component 108, predictive generating component 110, and/or the dual convolution component).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). System 100 can be associated with, such as accessible via, a computing environment 800 described below with reference to FIG. 8. For example, system 100 can be associated with a computing environment 800 such that aspects of processing can be distributed between system 100 and the computing environment 800.

The proposed innovation is a machine learning-based system that is used to generate optimum predictive graph based inputs. Its input is a graph whose vertices may have node feature vectors and edges may have edge attribute (feature) vectors and the edges are directed. Its machine learning algorithm exploits multiple layers of vertex-centric message-passing (a.k.a., graph convolution) to aggregate the input features for each vertex from neighbor vertices and connecting edges.

It is common for GNNs to employ “message-passing” or “graph convolution”, where node features of neighbor nodes are aggregated to each node. For this innovation, the technique is extended to capture roles of edge attributes and neighbor nodes in different ways between incoming and outgoing edges.

A message-passing layer in this GNN innovation exploits two kinds of aggregation processes; one is for aggregation of features through incoming edges, and another one is for aggregation of features through outgoing edges. This incoming edge data and outgoing data is an integral part of this innovation. This task is the primary function of the dual flow convolution component 112. Then certain trainable functions (e.g., a linear NN parameter multiplication) can be applied to the aggregated values of the incoming edges and outgoing edges, respectively. The result is concatenated to form a one vector as its output.

The node level aggregation component 108 is also used in the message-passing layer to exploit an aggregation process, where certain trainable functions (e.g., a linear NN parameter multiplication) are applied for the neighbor node feature vectors and edge attribute vector of an edge that connects to the neighbor node, respectively. As the conclusion of these various processes, the predictive generating component 110 provides a prediction for an input graph, or for a part of a graph such as a node (vertex), an edge, or a subgraph, based on the node attributes (features) and edge attributes that are attached to the input graph.

FIG. 2 illustrates a diagram of node level aggregation with edge attributes of a non-limiting system with one or more embodiments described herein. This diagram reflects the basic architecture of node and edge relationships. It is referred to in this innovation as the functionality component 108 in FIG. 1. On a graph, each node typically has associated feature vectors representing its attributes, and each edge can have associated feature vectors representing its attributes. Node features describe the properties of individual nodes, while edge features describe the properties of the relationships between nodes. An example of an edge attribute in a Graph Neural Network (GNN) is the “weight” attribute. The weight attribute represents a numerical value associated with the strength or importance of the connection between two nodes in a graph. This edge attribute is commonly used in various graph-based applications and can provide additional information about the relationships between nodes.

For instance, in a social network graph, the weight attribute of an edge could represent the strength of the friendship or connection between two users. A higher weight might indicate a stronger connection, while a lower weight might indicate a weaker connection. In a transportation network, edge weights could represent the distance between two locations, the travel time, or even the cost of traversing a particular route. An example of a node attribute in a Graph Neural Network (GNN) is the “age” attribute in a social network graph. In this context, the “age” attribute represents the age of each user in the social network. Node attributes like “age” provide information about the intrinsic properties or characteristics of individual nodes in the graph.

As depicted on FIG. 2, the edge attributes eⱼᵢ as well as node features hⱼ are aggregated from neighbor nodes and edges to generate the output of that layer, identified as yᵢ where “i” is 0 in this depiction. Edge attributes eⱼᵢ is an edge attribute feature vector of edge (j,i). The node attribute feature for a specific node is hⱼ.

The focus node is shown as “i” 234 as in the ith node and in this case its node “0” and depicted as 222. The neighbor nodes are identified as node 1, 228, node 2 as 202, node 3 as 210 and node 4 as 218. Each of the neighbor nodes have features identified as hⱼ, the node feature vector where j represents neighbor node number. In this diagram each node feature is shown as 4 different inputs. The 4 different node feature vectors would be hⱼ, where j would be identified as 1, 2, 3 and 4 based on the node identification. So for node 1, the node feature vector would be 230 and shown as an input 232 (input refers to aggregation of a neighbor node) for the primary node 222. The same concept would apply to each neighboring node, so for node 2 which is identified as 202, 238 is the node feature and its input is 236. For node 3, which is identified as 210, 206 is the node feature and 208 as the input. For node 4, which is identified as 218, 220 is the node feature. For the edge feature from node 1 228 to the primary node 222 would be 226, the edge feature from node 2 202 to the primary node is 204, the edge feature from node 3 204, would be 212 This concept would apply to as many node and edge relationships on a graph, as decided by a user. The innovation has modified standard GNN computational equations and instead apply the following equations to produce the content for the output layer:

$$\begin{matrix}{y}_{i}^{In} = W {\sum }_{j ∈ {N}_{In} ( i )} {a}_{ji} [ {h}_{j} ‖ {e}_{ji} ] , \\ {y}_{i}^{Out} = {W}^{′} {\sum }_{j ∈ {N}_{Out} ( i )} {a}_{ij}^{′} [ {h}_{j} ‖ {e}_{ij} ] , \\ {a}_{ij}^{′} = a ( {h}_{i} , {h}_{j} , {e}_{ij} \vert {w}^{′} , {β}^{′} ) \\ {y}_{i} = [ {y}_{i}^{In} ‖ {y}_{i}^{Out} ]\end{matrix}$$

The individual variables are identified as:
(W, w, β: trained parameters)
hⱼ: node feature vector
yᵢ: output of a layer (node embedding)
N(i): set of neighbor nodes of node i.
   N(i)=N(i) for a directed graph.
   N(i)=N_{In}(i)∪N_{Out}(i) for a non-directed graph.
eⱼᵢ: edge attribute (feature) vector of edge (j,i).
[u∥v]: vector concatenation
aᵢⱼ: attention coefficient. Σ_{j∈N(i)}aᵢₙ=1
A novelty for this innovation is that for each node, the aggregated features are enhanced by concatenating the edge attributes, as shown by the circled equations for yᵢₙ^{In} and yᵢ^{Out}.

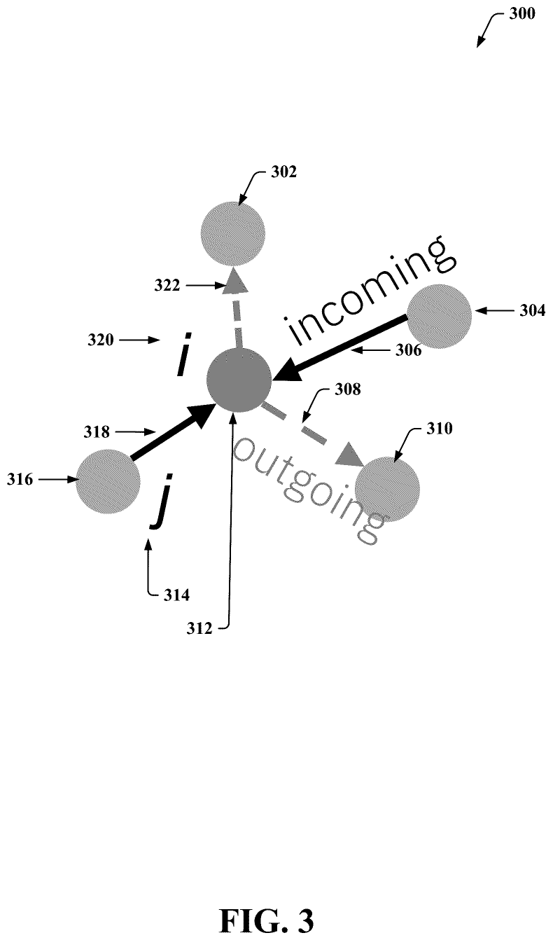

FIG. 3 illustrates a diagram of dual flow convolution encompassing incoming and outgoing edges of a non-limiting system in accordance with one or more embodiments described herein.

Dual flow convolution will account for content related to aggregation of features through incoming edges and aggregation of features through outgoing edges. GNNs work with incoming and outgoing edges using multiple processes as described below:

Node Representation: GNNs start with an initial representation for each node in the graph. This representation can be a feature vector associated with the node.

Message Passing: GNNs perform message passing between nodes in the graph. In this step, each node aggregates information from its neighboring nodes based on the edges. When a node receives messages from its neighbors, it considers both incoming and outgoing edges. For incoming edges: A node collects information from its incoming neighbors. It aggregates the features of nodes connected by incoming edges to update its own representation. For outgoing edges: A node can also send messages to its neighboring nodes through its outgoing edges. This allows information to flow from one node to another.

Aggregation and Update: During the message passing process, information is aggregated from neighbors. How this aggregation is performed depends on the specific GNN architecture. Common aggregation methods include sum, mean, or more complex mechanisms like graph convolution operations.

Node Update: The aggregated information is used to update the node's representation. The updated representation typically combines the node's current representation with the aggregated information. This step is also influenced by the node's own features and the type of aggregation used.

Iteration: GNNs often perform multiple iterations of message passing. In each iteration, the nodes update their representations based on the information received from their neighbors. This allows the model to capture information from nodes that are further away in the graph. Output Layer: After multiple iterations, the final node representations are used for various tasks, such as node classification, graph classification, link prediction, or other graph-related tasks.

GNNs can be customized and modified in various ways to suit different graph-based applications. Different GNN architectures, like Graph Convolutional Networks (GCNs), GraphSAGE, GAT (Graph Attention Network), and more, may use slightly different mechanisms for message passing and aggregation, but the fundamental idea of considering both incoming and outgoing edges can be applied commonly to those different types of GNNs.

This innovation will follow a process in which the aggregation of incoming and outgoing edges will be done separately. Different NN (neural network) parameters will be assigned for the incoming and outgoing edges to learn the different roles of those edges and the outputs of the incoming and outgoing edges will be concatenated and stored separately.

Further in FIG. 3 depicts both incoming and outgoing edges. There are 4 nodes and this example shows the nodes as 302, 304, 310 and 316, they are not individually numbered as it would not be relevant for our task. These could be considered the neighbor nodes and the primary node as 312 with “j” 314 being a neighbor and “i” being the primary 320 (also identified as 312. In this example the incoming edges are identified as 306 and 318. Incoming edges are edges that connect other nodes to the node of interest (the node you are focusing on during message passing). When a node receives messages from its incoming neighbors, it collects information from nodes connected to it through these incoming edges. The information collected from incoming edges is used to update the node's representation, allowing it to take into account the features and connections of nodes that have edges pointing to it.

The outgoing edges are represented by 322 and 308. Outgoing edges are edges that connect the node of interest to other nodes in the graph. When a node receives messages from its outgoing neighbors, it collects information from nodes connected to it through these outgoing edges. The same aggregation mechanism is used for outgoing edges. Therefore, the messages are passed in the reverse direction of edges (i.e., from the target to the source) in the case of outgoing edges. This may seem counterintuitive, but consistent with the equations in.

The information collected from outgoing edges is used to update the node's representation, allowing it to take into account the features and connections of nodes that have edges pointed by it.

The equations used for incoming and outgoing edges are a novelty for this innovation as the outputs of the incoming and outgoing layers are concatenated.

$$\begin{matrix}\begin{matrix}{y}_{i}^{I n} = W {\sum }_{j ∈ {N}_{I n} ( i )} {a}_{i j} {h}_{j} , & {a}_{i j} = a ( {h}_{i} , {h}_{j} \vert w , β )\end{matrix} \\ \begin{matrix}{y}_{i}^{O u t} = {W}^{′} {\sum }_{j ∈ {N}_{O u t} ( i )} {a}_{i j}^{′} {h}_{j} , & {a}_{i j}^{′} = a ( {h}_{i} , {h}_{j} \vert {w}^{′} , {β}^{′} )\end{matrix} \\ {y}_{i} = [ {y}_{i}^{I n} ‖ {y}_{i}^{O u t} ]\end{matrix}$$

The individual variables are identified as:
(W, w, β: trained parameters)
hⱼ: node feature vector
yᵢ: output of a layer (node embedding)
N(i): set of neighbor nodes of node i.
   N(i)=N_{In}(i) for a directed graph.
   N(i)=N_{In}(i)∪N_{Out}(i) for a non-directed graph.
eⱼᵢ: edge attribute (feature) vector of edge (j,i).
[u∥v]: vector concatenation
aᵢⱼ: attention coefficient. Σ_{j∈N(i)}aᵢₙ=1.

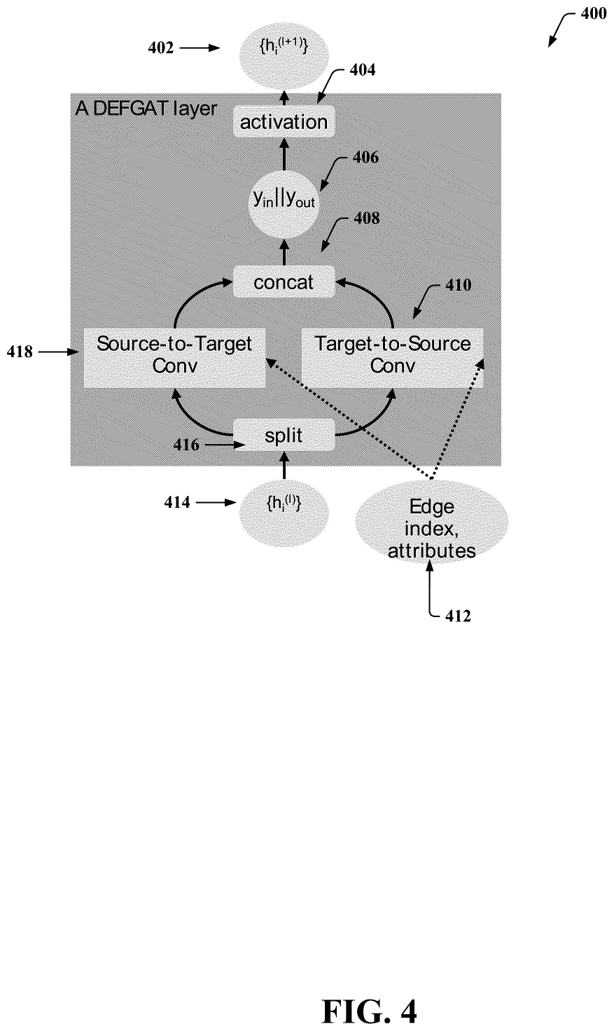

FIG. 4 illustrates a component overview diagram of dual flow convolution for a non-limiting system in accordance with one or more embodiments described herein. This is a component diagram of the invention to describe the data flow and relations of the components to implement a NN model. At 414, the node features are an input into the initial software component where they are split 416 into two types of data, one data set will go to the “Source to Target” 418 databank and the second set will go to “Target to Source” 410 databank. The edge index attributes 412 are sent as inputs also into the two data banks 418 and 410. The equations identified in FIGS. 2 & 3 for are executed respectively for node and edge attribute aggregation along with dual flow convolution, and outputs are concatenated (406 &408). This step then processes through an activation layer of a NN layer 404 and proceed to 402 in which the next node will restart the cycle. This process will be implemented in an iterative format to account for all layers defined by the user. This DEFGAT layer will also be a sub-process within the entire functional flow for this innovation.

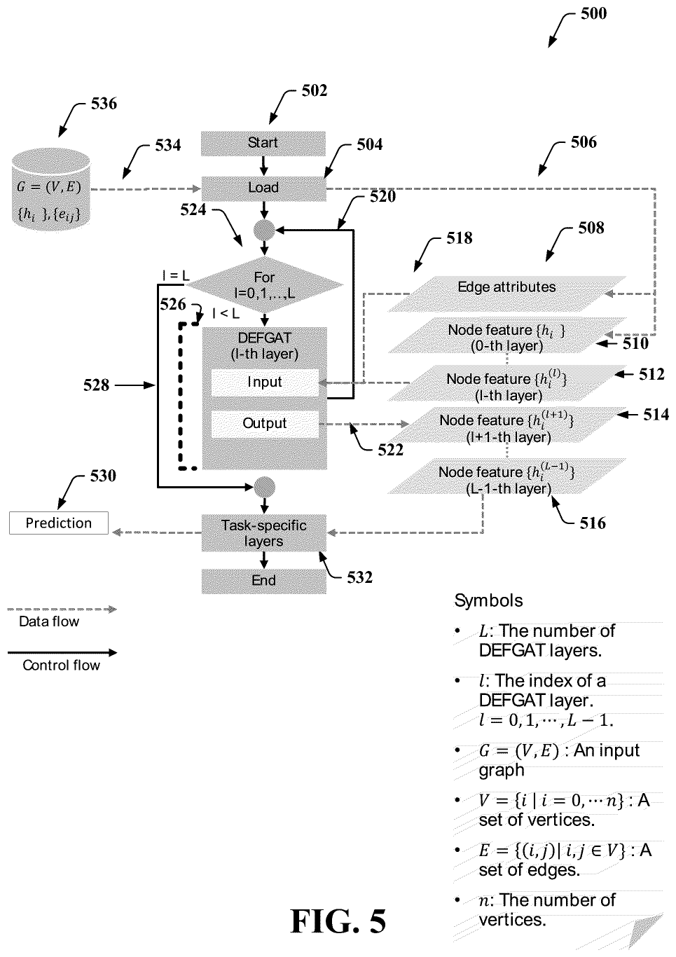

FIG. 5 illustrates the overall innovation flow chart of GNN functionality for a non-limiting system in accordance with one or more embodiments described herein. The GNN is initially provided data 536 containing an individual graph. The graph will be composed of vertices and sets of edges also depicted in 536, all the defined variables are shown on the bottom right of the diagram. The data is for all nodes or vertices that will encompass the graph. The process starts 502 and loading of the data 534 into the software 504 triggers the GNN cycle. The content also contains 506 edge attributes and node feature data. This iterative technique 520 will execute for layers “L” 524 as the computational equations will be exercised as each layer is processed until the final layer is completed 528. The layer processing in the DEFGAT compartment 526 is depicted in an abstract manner for this diagram but is the same process as shown in the component diagram FIG. 4. The specific input data is node features for a layer (510,512) which will be processed to pipe as an output 522 into the next layer (514) up to the final node “Lth” layer 516 along with edge attributes 508. All the input data is processed utilizing the equations discussed in FIGS. 2 & 3 and each upper layer is fed data 522 from the previous layer. After each layer has been processed, data will be passed to task specific layers 532 that function with a purpose to generate a final predictive value 530. The task layers need not to operate as the DEFGAT layers which are for node & edge processing.

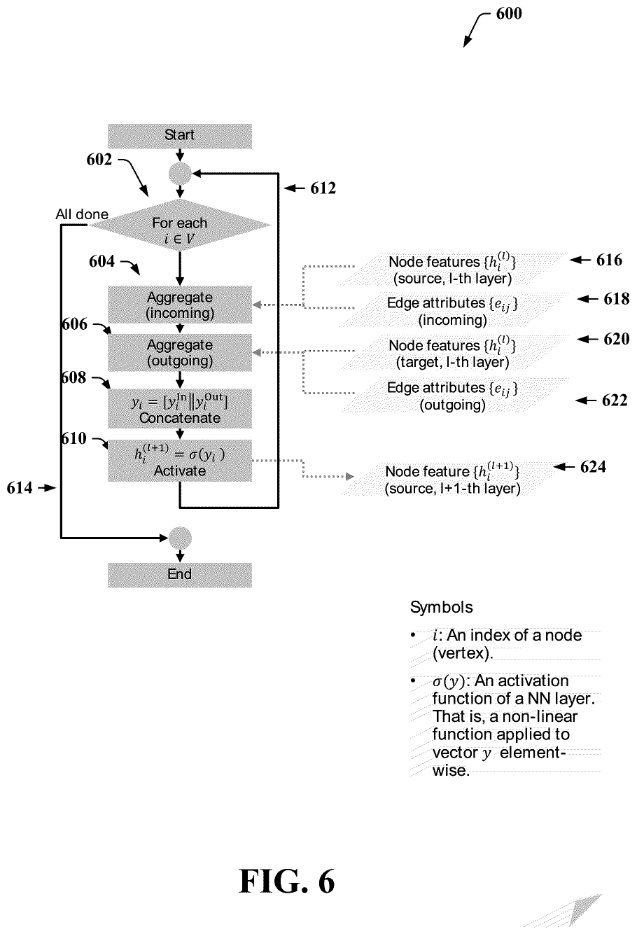

FIG. 6 illustrates the flow chart for the DEFGAT layer within the innovation overall flow chart of a non-limiting system in accordance with one or more embodiments described herein. This illustration is a detailed flow of 526 in FIG. 5, it provides a clear picture of the inner working in the DEFGAT process. For each node the sequence will iteratively process the incoming node features and edge attributes and then follow the concatenation process as discussed previously. As the flow chart depicts, a specific node (indexed) 602 will start the iterative cycle and the cycle will run until the final node is processed 612. The aggregation of incoming edge attributes 618 and node features 616 will be executed in the incoming aggregation section 604. The aggregation of outgoing edge attributes 622 and node features 620 will be executed in the outgoing aggregation section 606. As this computation is conducted for this layer (all layers will follow), the output layer value 608 will be the result of concatenation with the equation:

$${y}_{i} = [ {y}_{i}^{I n} ‖ {y}_{i}^{O u t} ]$$

Next a non-linear activation function 610 will process the data, send an output to the next node 624 and the cycle will restart 612 until all the nodes have been implemented 614.

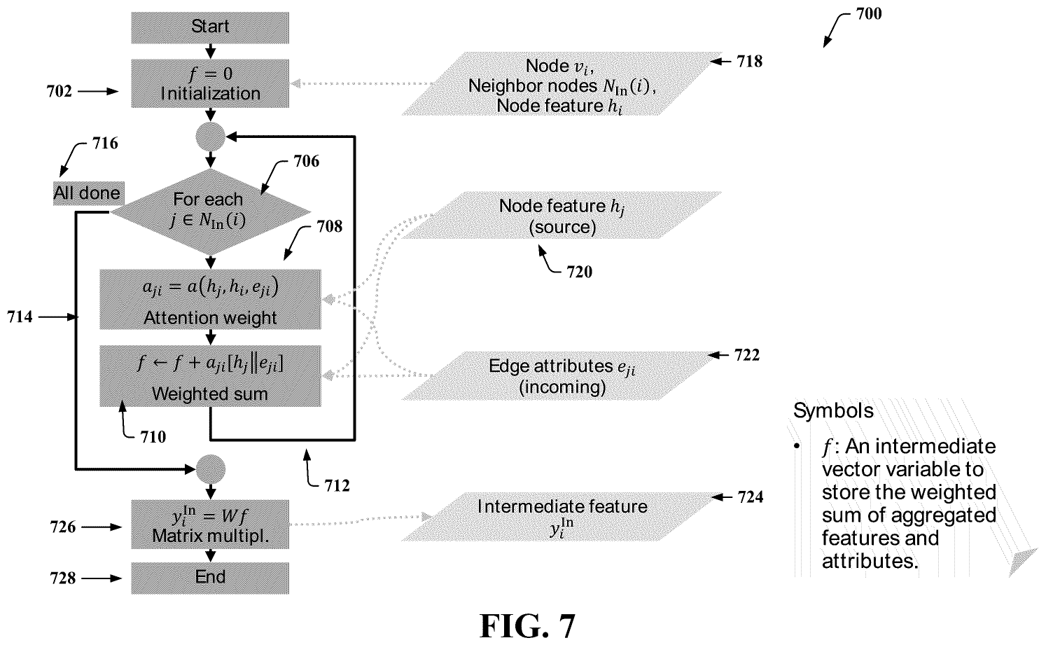

FIG. 7 illustrates the detailed sequence of block 604 as it represents the incoming aggregation process. The flow chart starts with initializing an intermediate vector variable “f” 702 which will store the weighted sum of aggregated features and attributes. There are neighbor nodes and features 718 that are needed for the initiation. After this point, the chart will start an iterative cycle 706 for the nodes and will stop when the nodes are accounted for. During this iterative cycle inputs will be provided for node features 720 and edge attributes 722. The attention weight 708 is calculated by the formula aⱼᵢ=a(h₁, hᵢ, eⱼᵢ) where aⱼᵢ is the attention weight, hⱼ and hᵢ level are the node feature vectors and eⱼᵢ is the edge attribute.

Its important to note this is for incoming aggregation, there will be a very similar flow chart for outgoing, this will be discussed as this section progresses. After the attention weight, the weighted sum “f” 710 is calculated using the equation for that node f←f+aⱼᵢ[hⱼ∥eⱼᵢ] where “f” 710 is the accumulated weighted sum, not to be confused with the original “f” 702 which was a starting point value of zero. This now starts the first step of iteration as the flow chart cycles 712 to the next node. As this cycle continues through the nodes, it terminates after the nodes are accounted for and the output layer value is derived in 726 with the equation yᵢ^{In}=wf where yᵢ^{In} represents the output of a layer along. Intermediate feature 724 can also be an offshoot of 726. As pointed out earlier, that flow process was for aggregation incoming, as far as outgoing which is block 606 (Aggregation (outgoing)) the flow chart will be quite similar to FIG. 7. The only differences would be: “In” is changed to “Out”, the attention coefficient “aⱼᵢ” is changed to “a′ij”, “source” is changed to “target”, and “incoming” is changed to “outgoing”.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

FIG. 8 illustrates a block diagram of an example, non-limiting, operating environment in which one or more embodiments described herein can be facilitated. FIG. 8 and the following discussion are intended to provide a general description of a suitable operating environment 800 in which one or more embodiments described herein at FIGS. 1-7 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, such as Ai GNN prediction code 845. In addition to block 845, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 845, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 845 in persistent storage 813.

COMMUNICATION FABRIC 811 is the signal conduction paths that allow the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface type operating systems that employ a kernel. The code included in block 845 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

What is claimed is:

1. A system, comprising:
a memory that stores computer executable components;
a processor that executes computer executable components stored in the memory, wherein the computer executable components comprise:
a convolution aggregation component that aggregates features through incoming edges, and aggregates features through outgoing edges to learn the different roles of those edges; and
a node level aggregation component that aggregates edge attributes and node features from neighborhood nodes and edges to optimize computing workload and memory; and
a generating component that generates a prediction for an input graph, or for a part of a graph such as a node (vertex), an edge, or a subgraph, based on the node attributes (features) and edge attributes that are attached to the input graph.

2. The computer implemented system of claim 1, further utilizing distinct trainable functions that are applied to aggregated values of the incoming edges and outgoing edges, respectively, to form a vector as its output.

3. The computer implemented system of claim 1, wherein the convolution aggregation component utilizes an equation for yᵢ^{In} as follows:
$${y}_{i}^{I n} = W {\sum }_{j ∈ {N}_{I n} ( i )} {a}_{i j} {h}_{j} , \qquad {a}_{i j} = a ( {h}_{i} , {h}_{j} \vert w , β )$$
wherein:
Symbols:
(W, w, β: trained parameters)
hⱼ: node feature vector
yᵢ: output of a layer (node embedding)
N(i): set of neighbor nodes of node i.
N(i)=N_{In}(i) for a directed graph.
N(i)=N_{In}(i)∪N_{Out}(i) for a non-directed graph.
eⱼᵢ: edge attribute (feature) vector of edge (j,i).
[u∥v]: vector concatenation
aᵢⱼ: attention coefficient. Σ_{j∈N(i)}aᵢₙ=1

4. The computer implemented system of claim 3, wherein the convolution aggregation component utilizes an equation for yᵢ^{Out} as follows:
$${y}_{i}^{O u t} = {W}^{′} {\sum }_{j ∈ {N}_{O u t} ( i )} {a}_{i j}^{′} {h}_{j} , \qquad {a}_{i j}^{′} = a ( {h}_{i} , {h}_{j} \vert {w}^{′} , {β}^{′} )$$

5. The computer implemented system of claim 4, wherein the convolution aggregation component utilizes an equation for yᵢ as follows:
$${y}_{i} = [ {y}_{i}^{I n} ‖ {y}_{i}^{O u t} ]$$

6. The computer implemented system of claim 1, wherein the node level aggregation component utilizes an equation for yᵢ^{In} as follows:
$$\begin{matrix}{y}_{i}^{I n} = W {\sum }_{j ∈ {N}_{I n} ( i )} {a}_{j i} [ {h}_{j} ‖ {e}_{j i} ] , \\ {a}_{j i} = a ( {h}_{j} , {h}_{i} , {e}_{j i} \vert w , β )\end{matrix}$$
Symbols:
(W, w, β: trained parameters)
hⱼ: node feature vector
yᵢ: output of a layer (node embedding)
N(i): set of neighbor nodes of node i.
N(i)=N_{In}(i) for a directed graph.
N(i)=N_{In}(i)∪N_{Out}(i) for a non-directed graph.
ej: edge attribute (feature) vector of edge (j,i).
[u∥v]: vector concatenation
aᵢⱼ: attention coefficient. Σ_{j∈N(i)}aᵢₙ=1

7. The computer implemented system of claim 1, wherein the node level aggregation component utilizes an equation for yᵢ^{Out} as follows:
$$\begin{matrix}{y}_{i}^{O u t} = {W}^{′} {\sum }_{j ∈ {N}_{Out} ( i )} {a}_{i j}^{′} [ {h}_{j} ‖ {e}_{i j} ] , \\ {a}_{i j}^{′} = a ( {h}_{i} , {h}_{j} , {e}_{i j} \vert {w}^{′} , {β}^{′} )\end{matrix}$$
Symbols:
(W, w, β: trained parameters)
hⱼ: node feature vector
yᵢ: output of a layer (node embedding)
N(i): set of neighbor nodes of node i.
N(i)=N_{In}(i) for a directed graph.
N(i)=N_{In}(i)∪N_{Out}(i) for a non-directed graph.
eⱼᵢ: edge attribute (feature) vector of edge (j,i).
[u∥v]: vector concatenation
aᵢⱼ: attention coefficient. Σ_{j∈N(i)}aᵢₙ=1

8. The computer implemented system of claim 7, wherein the node level aggregation component utilizes an equation for yᵢ as follows:
$${y}_{i} = [ {y}_{i}^{I n} ‖ {y}_{i}^{O u t} ]$$

9. The computer implemented system of claim 8, wherein the edge attribute features are concatenated for each node.

10. A computer-implemented method, comprising:
convolution aggregation by the system, that aggregates features through incoming edges, and aggregates features through outgoing edges to produce optimized NN prediction; and
node level aggregation by the system, that aggregates edge attributes and node features from neighborhood nodes and edges to optimize computing workload and memory.
a generating by the system, that generates a prediction for an input graph, or for a part of a graph such as a node (vertex), an edge, or a subgraph, based on the node attributes (features) and edge attributes that are attached to the input graph.

11. The computer implemented of claim 10, further comprising, applying by the system, utilization of trainable functions to the aggregated values of the incoming edges and outgoing edges, respectively, to form a vector as its output.

12. The computer-implemented method of claim 10, further comprising, executing the convolution aggregation component equation by the system, for yᵢ^{In} as follows:
$${y}_{i}^{I n} = W {\sum }_{j ∈ {N}_{I n} ( i )} {a}_{j i} {h}_{j} , \qquad {a}_{j i} = a ( {h}_{j} , {h}_{i} \vert w , β )$$

13. The computer-implemented method of claim 12, further comprising, executing the convolution aggregation component equation by the system, for yᵢ^{Out} follows:
$${y}_{i}^{O u t} = {W}^{′} {\sum }_{j ∈ {N}_{o u t} ( i )} {a}_{i j}^{′} {h}_{j} , \qquad {a}_{i j}^{′} = a ( {h}_{i} , {h}_{j} \vert {w}^{′} , {β}^{′} )$$

14. The computer-implemented method of claim 13, further comprising, executing the convolution aggregation component equation by the system, for yᵢ as follows:
$${y}_{i} = [ {y}_{i}^{I n} ‖ {y}_{i}^{O u t} ]$$

15. The computer-implemented method of claim 10, further comprising, executing the node level aggregation component equation by the system, for yᵢ^{Out} as follows:
$$\begin{matrix}{y}_{i}^{I n} = W {\sum }_{j ∈ {N}_{I n} ( i )} {a}_{j i} [ {h}_{j} ‖ {e}_{j i} ] , \\ {a}_{j i} = a ( {h}_{j} , {h}_{i} , {e}_{j i} \vert w , β )\end{matrix}$$

16. The computer-implemented method of claim 10, further comprising, executing the node level aggregation component equation by the system for yᵢ^{Out} as follows:
$$\begin{matrix}{y}_{i}^{O u t} = {W}^{′} {\sum }_{j ∈ {N}_{Out} ( i )} {a}_{i j}^{′} [ {h}_{j} ‖ {e}_{i j} ] , \\ {a}_{i j}^{′} = a ( {h}_{i} , {h}_{j} , {e}_{i j} \vert {w}^{′} , {β}^{′} )\end{matrix}$$

17. The computer-implemented method of claim 10, further comprising, executing the node level aggregation equation by the system, for yᵢ as follows:
$${y}_{i} = [ {y}_{i}^{I n} ‖ {y}_{i}^{O u t} ]$$

18. A computer program product comprising a computer readable storage medium having program instructions embodied therewith, the program instructions executable by processor to cause the processor to:
aggregate convolution by the processor, features through incoming edges, and aggregate features through outgoing edges to produce optimized NN prediction; and
aggregate node level aggregation, by the processor, edge attributes and node features from neighborhood nodes and edges to optimize computing workload and memory.
generate prediction by the processor, that generates a prediction for an input graph, or for a part of a graph such as a node (vertex), an edge, or a subgraph, based on the node attributes (features) and edge attributes that are attached to the input graph.

19. The computer program product of claim 18, wherein the program instructions are executable by the processor to cause the processor to:
apply by the processor, distinct trainable functions to the aggregated values of the incoming edges and outgoing edges, respectively and the result is concatenated to form a one vector as its output.

20. The computer program product of claim 18, wherein the program instructions are executable by the processor to cause the processor to:
execute the convolution aggregation equation by the processor for yᵢ^{In} is as follows:
$${y}_{i}^{I n} = W {\sum }_{j ∈ {N}_{I n} ( i )} {a}_{j i} {h}_{j} , \qquad {a}_{j i} = a ( {h}_{j} , {h}_{i} \vert w , β )$$
